(19) United States
(12) Patent Application Publication
(10) Pub. No.: US 2025/0363168 A1
(43) Pub. Date: Nov. 27, 2025

(54) AESTHETIC IMAGE RETRIEVAL SYSTEM AND METHOD

(71) Applicant: Microsoft Technology Licensing, LLC, Redmond, WA (US)

(72) Inventors: Yifei MA, San Mateo, CA (US); Qi DAI, Beijing (CN); Yixuan WEI, Beijing (CN); Miaosen ZHANG, Beijing (CN); Yuhui YUAN, Beijing (CN); Ji LI, San Jose, CA (US)

(73) Assignee: Microsoft Technology Licensing, LLC, Redmond, WA (US)

(21) Appl. No.: 18/674,137

(22) Filed: May 24, 2024

(51) Int. Cl. G06F 16/58; G06F 16/51

(52) U.S. Cl. CPC G06F 16/5866; G06F 16/51

(57) ABSTRACT

A method of retrieving visual content includes receiving user input defining an initial search query from a client application. The initial search query and a meta prompt are then delivered to a refined query generating model which is trained to analyze the initial search query to determine user intent and to generate a refined search query based on the initial search query and the meta prompt. The refined search query is delivered to a visual content retrieval model which retrieves aesthetic visual content with reference to a visual content index. Retrieved aesthetic visual content is returned to the client application.

### BACKGROUND

Text-to-image (or text-to-visual content) search refers to the capability of a search system to retrieve visual content based on textual descriptions provided by the user. Rather than relying solely on keywords or manually browsing through images, users can describe what they are looking for in natural language, and the system will return relevant visual content that matches their description. It offers a more intuitive and user-friendly way for users to search for visual content. Instead of struggling to come up with the right keywords, users can describe what they want in their own words, making the search process more accessible to a wider range of users. Text-to-image search has applications in various domains, including e-commerce, content-based image retrieval, visual search engines, and more. It allows users to find images based on detailed descriptions, which can be particularly useful for tasks such as product search, fashion recommendation, interior design, and art exploration.

Visual content retrieval system design typically involves a trade-off between system complexity and performance. For example, some visual content retrieval systems rely on complex model architectures having multiple stages which can require significant amounts of computing resources to implement which in turn can lead to computational inefficiency and increased difficulty in deployment and maintenance. In addition, multi-stage models typically require intricate pre-processing and post-processing steps in addition to feature extraction which makes multi-stage systems challenging to deploy, optimize, and scale effectively. To reduce complexity, some visual content retrieval systems utilize single stage model architectures which can reduce the computing resources required to implement the system and in turn simplify deployment and maintenance of the system. However, single-stage models are typically not capable of taking user intent and/or context into consideration in selecting visual content to retrieve. As a result, single-stage models are generally not capable of providing a personalized and context-aware search experiences for users.

Hence, what is needed is a system and method of retrieving visual content that enables streamlined and simplified visual content retrieval while maintaining performance and that is capable of taking user intent and context into consideration in order to provide personalized and context-aware search experiences for user.

### SUMMARY

In one general aspect, the instant disclosure presents a data processing system having a processor and a memory in communication with the processor wherein the memory stores executable instructions that, when executed by the processor alone or in combination with other processors, cause the data processing system to perform multiple functions. The function may include receiving user input defining an initial search query for a visual content retrieval system from a client application, the initial search query describing at least one characteristic of visual content to be retrieved by the visual content retrieval system; delivering the initial visual content search query and a meta prompt to a refined query generating model as natural language inputs, the refined query generating model being trained to analyze the initial search query to determine user intent and to generate a refined search query with wording selected to cause a visual content retrieval model of the visual content retrieval system to retrieve aesthetic visual content based on the initial search query and the meta prompt; delivering the refined search query to the visual content retrieval model, the visual content retrieval model being trained to retrieve the aesthetic visual content with reference to a visual content index, the visual content index indexing retrievable visual content for the visual content retrieval system; receiving the retrieved aesthetic visual content from the visual content retrieval model; and returning the retrieved aesthetic visual content to the client application.

In yet another general aspect, the instant disclosure presents a method of retrieving visual content using a visual content retrieval system. The method includes receiving user input defining an initial search query for a visual content retrieval system from a client application, the initial search query describing at least one characteristic of visual content to be retrieved by the visual content retrieval system; delivering the initial visual content search query and a meta prompt to a refined query generating model as natural language inputs, the refined query generating model being trained to analyze the initial search query to determine user intent and to generate a refined search query with wording selected to cause a visual content retrieval model of the visual content retrieval system to retrieve aesthetic visual content based on the initial search query and the meta prompt; delivering the refined search query to the visual content retrieval model, the visual content retrieval model being trained to retrieve the aesthetic visual content with reference to a visual content index, the visual content index indexing retrievable visual content for the visual content retrieval system; receiving the retrieved aesthetic visual content from the visual content retrieval model; and returning the retrieved aesthetic visual content to the client application.

In a further general aspect, the instant application describes a computer readable medium on which are stored instructions that when executed cause a programmable device to perform functions of receiving user input defining an initial search query for a visual content retrieval system from a client application, the initial search query describing at least one characteristic of visual content to be retrieved by the visual content retrieval system; delivering the initial visual content search query and a meta prompt to a refined query generating model as natural language inputs, the refined query generating model being trained to analyze the initial search query to determine user intent and to generate a refined search query with wording selected to cause a visual content retrieval model of the visual content retrieval system to retrieve aesthetic visual content based on the initial search query and the meta prompt; delivering the refined search query to the visual content retrieval model, the visual content retrieval model being trained to retrieve the aesthetic visual content with reference to a visual content index, the visual content index indexing retrievable visual content for the visual content retrieval system; receiving the retrieved aesthetic visual content from the visual content retrieval model; and returning the retrieved aesthetic visual content to the client application.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 is a diagram showing an example computing environment in which aspects of the disclosure may be implemented.

FIG. 2 shows an example implementation of a visual content retrieval system of FIG. 1 and a client application for interacting with the visual content retrieval system.

FIG. 3 shows an example implementation of a visual content retrieval component of the visual content retrieval system of FIG. 2.

FIG. 4 shows an example implementation of a reinforcement training system for the visual content retrieval system of FIG. 2.

FIG. 5 shows a flowchart of a method for aesthetic visual content retrieval using the visual content retrieval system of FIG. 2.

FIG. 6 is a block diagram of an example computing device, which may be used to provide implementations of the mechanisms described herein; and

FIG. 7 is a block diagram illustrating components of an example machine configured to read instructions from a machine-readable medium.

### DETAILED DESCRIPTION

Text-to-image retrieval is a process that involves searching for images based on textual descriptions or queries. In this approach, users input text describing the image they are looking for, and the system retrieves images that match the description. Text-to-image retrieval systems typically perform two main tasks: (1) query analysis and (2) image search. Query analysis typically involves the use of natural language processing (NLP) techniques to analyze and understand the textual input provided by the user. Query processing tasks can include parsing the text, extracting key features, and understanding the semantics and context of the query. Once the textual query has been analyzed, the system searches through a source of images to find ones that best match the description provided in the text. This is usually done using image similarity algorithms that compare the features extracted from the text with features extracted from the images.

Current visual retrieval systems face two major drawbacks. Firstly, many rely on complex architectures with multiple stages, leading to computational inefficiency and increased complexity in deployment and maintenance. These multi-stage systems often involve intricate preprocessing steps, feature extraction, and post-processing stages, making them challenging to optimize and scale effectively. Consequently, there is a growing need for streamlined solutions that simplify the retrieval process while maintaining performance.

Secondly, while some systems attempt to address complexity by employing single-stage models, they often overlook an essential aspect: user intent. These models typically focus solely on learning image-text pairings to optimize relevancy without considering the broader context of user preferences. As a result, the retrieved results may lack the nuanced understanding required to meet user expectations effectively. To enhance the user experience, there is a pressing need for visual retrieval systems that can incorporate and adapt to user intent dynamically, enabling more personalized and context-aware search experiences.

To address these technical problems, and more, in an example, this description provides technical solutions in the form of an intelligent visual content retrieval system that enables the retrieval of relevant, contextual, and aesthetic visual content within an efficient framework. As used herein, the term “visual content” refers to images, video, illustrations, graphics, and any type of content that uses visual elements to convey information. The visual content retrieval system utilizes a generative language model, such as a Large Language Model (LLM), to generate refined visual content queries based on user input that describes the visual content to be retrieved by the system and a tuned meta-prompt which includes detailed instructions for how to generate the refined visual content queries. The system includes an aesthetically aligned vision language model (i.e., a text-to-visual content retrieval model) which is trained to retrieve the top-k visual content that satisfies the refined query. The system utilizes Approximate k-Nearest Neighbor (ANN) search techniques to enable fast and efficient content selection and retrieval. The ANN search techniques include using an offline indexing system to generate an ANN index for one or more visual content sources (e.g., a content library). To generate the ANN index, the visual content is first mapped to an embedding space using an encoder, such as a transformer-based encoder, or other suitable machine learning (ML) or artificial intelligence (AI) model/algorithm. The embeddings are generated in a manner that enables the similarities between visual content items/features to be represented by the distances between embeddings. The visual content embeddings are then stored in a data structure, such as a vector database, to serve as the index for the visual content.

The vision language model is trained to process the refined query to generate a query feature vector which is compared to the visual content index to retrieve the top k visual content. To this end, the vision language model includes an encoder which maps the text of the refined search query to the same embedding space to which the visual content is mapped for the ANN index. The vision language model then processes the refined query embedding with regard to the visual content embeddings in the ANN index to retrieve the top k results. An ANN index enables fast and efficient searching by reducing the number of candidates that are searched for a given query. The goal of ANN searching is to find visual content embeddings (i.e., nearest neighbors) that approximate the query embedding without necessarily finding the exact nearest neighbor. For example, to enable fast searching of the ANN index, the embedding space may be divided into a plurality of zones. During search, the index is scanned and zones that are unlikely to have the nearest neighbors are omitted from the search, and locations with a higher possibility of having nearest neighbors are selected for searching. Using an ANN search/index is faster, but less accurate than brute force methods because, in essence, the index is a lossy representation of the data. Examples of ANN searching/indexing techniques which may be utilized to retrieve top k visual content include hashing-based, tree-based, quantization-based, and graph-based.

To further enhance the ability of the system to retrieve relevant and aesthetically pleasing visual content, the system utilizes usage-based reinforcement learning to tune the meta prompt and the visual content retrieval model. Usage-based reinforcement is implemented by collecting usage data, user preference data, and feedback data pertaining to the usage of the visual content retrieval system. This data can be used to derive user preferences with regard to preferred characteristics and types of visual content to retrieve based on query language. Derived user preferences can then be used in reinforcement training for meta prompt generation and text visual content retrieval. For example, the system may include a meta prompt generating model which may be used to periodically update the meta prompt used by the system based on derived user preference data. Similarly, the derived user preference data can be used for reinforcement training of the visual content retrieval model to improve results of the content retrieval processes.

The technical solutions described herein provide solutions to the technical problems associated with visual content retrieval. For example, rather than relying on complex multi-stage architectures prone to computational inefficiencies, the system described herein emphasizes simplicity and efficiency. By streamlining the retrieval process, it reduces the burden of intricate preprocessing, feature extraction, and post-processing stages, thereby enhancing performance and scalability. In addition, while traditional systems may overlook user intent, the solutions described herein place a strong emphasis on understanding and incorporating user intent dynamically. By considering the broader context of user dialog and utilizing LLM to rephrase the search query, the system aims to deliver more personalized and context-aware search experiences, ultimately enhancing user satisfaction.

In addition to optimizing for relevancy, the system also prioritizes the delivery of aesthetically pleasing visual content. By employing preference-based reinforcement learning into the retrieval process, it aims to enhance the overall user experience and engagement with the retrieved results. Finally, by combining streamlined architecture with a user-centric design and aesthetic content optimization, the solutions according to this disclosure offer significant advantages in terms of efficiency and performance by providing a balance between computational efficiency and retrieval effectiveness, thus ensuring that users receive high-quality results in a timely manner. Overall, the proposed approach represents a significant departure from traditional visual retrieval systems by placing a strong emphasis on simplicity, user-centric design, and aesthetic content optimization. Through these key differences, it aims to address the limitations of existing solutions and deliver a more satisfying and engaging user experience.

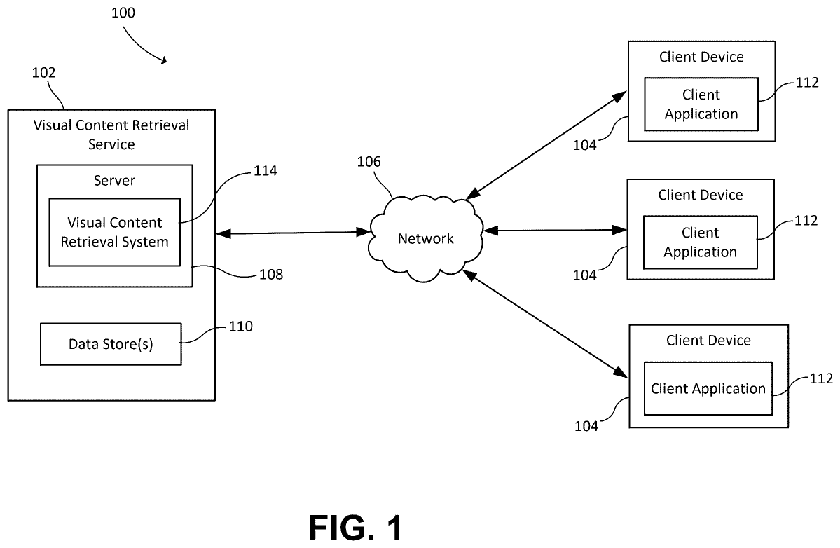

FIG. 1 shows an example computing environment 100 in which aspects of the disclosure may be implemented. The computing environment 100 includes a visual content retrieval service 102 and client devices 104 which communicate with each other via a network 106. The network 106 includes one or more wired, wireless, and/or a combination of wired and wireless networks. In some implementations, the network 106 includes one or more local area networks (LAN), wide area networks (WAN) (e.g., the Internet), public networks, private networks, virtual networks, mesh networks, peer-to-peer networks, and/or other interconnected data paths across which multiple devices may communicate. In some examples, the network 106 is coupled to or includes portions of a telecommunications network for sending data in a variety of different communication protocols. In some implementations, the network 106 includes Bluetooth® communication networks or a cellular communications network for sending and receiving data including via short messaging service (SMS), multimedia messaging service (MMS), hypertext transfer protocol (HTTP), direct data connection, WAP, email, and the like.

The visual content retrieval service 102 may be implemented as a cloud-based service or set of services. To this end, the visual content retrieval service 102 is executed on or includes at least one server 108 which is configured to provide computational and/or storage resources for implementing the visual content retrieval service 102. The server 108 is representative of any physical or virtual computing system, device, or collection thereof, such as, a web server, rack server, blade server, virtual machine server, or tower server, as well as any other type of computing system used to implement the visual content retrieval service 102. Servers are implemented using any suitable number and type of physical and/or virtual computing resources (e.g., standalone computing devices, blade servers, virtual machines, etc.). Visual content retrieval service 102 may also include one or more data stores 110 for storing data, programs, and the like for implementing and managing the visual content retrieval service 102. In FIG. 1, one server 108 and one data store 110 are shown, although any suitable number of servers and/or data stores may be utilized.

Client devices 104 enable users to access the visual content retrieval service 102 via the network 106. Client devices 104 can be any suitable type of computing device, such as personal computers, desktop computers, laptop computers, smart phones, tablets, gaming consoles, smart televisions and the like. Client devices 104 include at least one client application 112 that is configured to interact with and access the functionality provided by the visual content retrieval service 102. In various implementations, client application 112 is a dedicated application installed on the client device and programmed to interact with one or more services provided by cloud infrastructure. In some implementations, client application 112 is an add-on, extension, or the like that can be integrated into other applications to enable interaction with the visual content retrieval service 102. In some cases, client application 112 is a general-purpose application, such as a web browser, configured to access services and/or applications over the network 106.

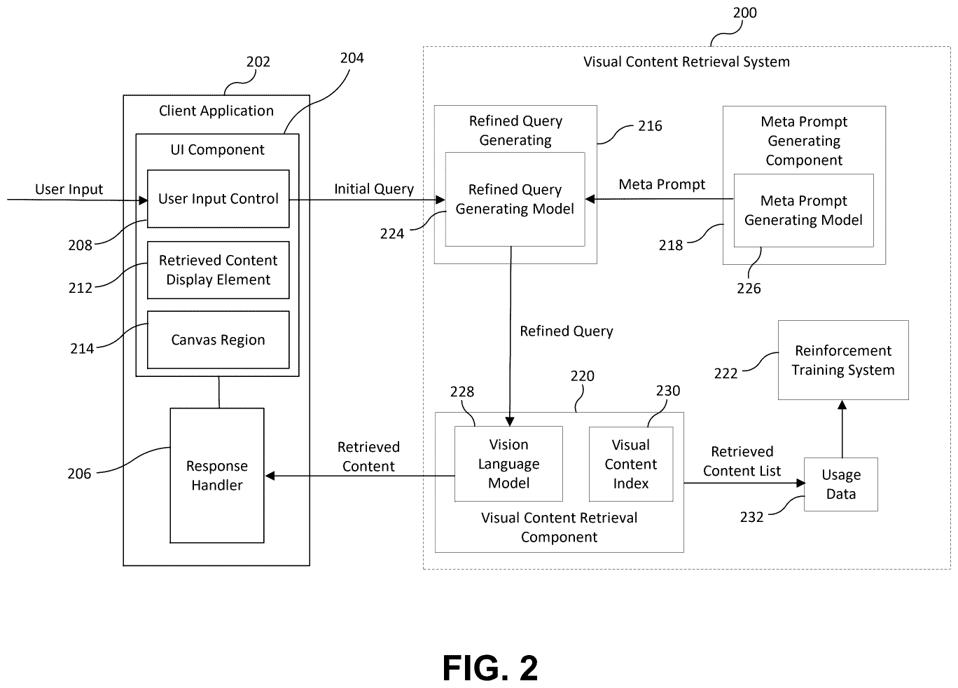

The visual content retrieval service 102 includes a visual content retrieval system 114 for implementing the visual content retrieval service 102. An example implementation of a visual content retrieval system 200 and client application 202 are shown in FIG. 2. Client application 202 includes a user interface (UI) component 204 and a response handler 206. The UI component 204 includes a user input control 208 for receiving user input which defines an initial visual content search query. The user input comprises an initial visual content search query (also referred to as a “prompt”) in natural language which identifies one or more objects, features, characteristics, etc. of the visual content that the user would like to be retrieved by the system. The initial visual content search query can range from a straightforward text phrase to a more intricate dialogue with a digital assistant AI. In various implementations, user input for an initial search query is collected until a sequence termination command is detected. The sequence termination command can be generated in response to activation of a send button or other UI control, or in response to receiving a predetermined keystroke or combination of keystrokes, such as hitting a TAB or Enter key on a keyboard.

Once the sequence termination command is detected, the client application 202 sends the user input for the initial search query to the visual content retrieval system 200. Visual content which is retrieved by the system 200 in response to the query is returned to the response handler 206. The response handler 206 in turn causes the retrieved visual content to be displayed in a retrieved content display element 212. Depending on the functionality of the client application, the UI component 204 may include a canvas region 214 in which visual content can be generated/edited. Although not shown in FIG. 2, the UI component 204 may include various UI controls for performing various visual content generation/editing tasks.

The visual content retrieval system 200 includes a refined query generating component 216, a meta prompt generating component 218, a visual content retrieval component 220, and a reinforcement training system 222. The initial search query is provided to the refined query generating component 216. The refined query generating component 216 includes a query generating model 224 which has been trained to process the initial query to generate a refined visual content query by rephrasing or rewording the initial query in a manner intended to elicit the retrieval of more aesthetic, contextual, and relevant visual content. The refined query generating model 224 is also trained to learn rules for determining user intent and/or context associated with a given query, query term, or combination of terms. For example, the model can be trained to recognize query language indicating that a user is shopping for a particular product and to retrieve relevant and aesthetic images of the product that include pricing information from various retailers. As another example, the model can be trained to recognize query language indicating that a user is looking for examples of how to decorate a room in their house and to retrieve relevant and aesthetic images of rooms having the decorative features/characteristics that the user wishes to see. In various implementations, the query generating model 224 comprises a generative language model, such as a Large Language Model (LLM), Generative Pre-trained Transformer (GPT)-based models (e.g., GPT-3, GPT-4, ChatGPT), or the like.

To further enhance the ability of the query generating model 224 to generate a refined visual content search query, the meta prompt generating component 218 is used to generate a meta prompt which is provided to the model 214 as input along with the initial search query. The meta prompt includes detailed instructions regarding how to generate the refined visual content query. For example, a meta prompt can read as follows: “You will be given a user query, and your task is to generate a concise image description in English that aligns with the user's intent. This description will facilitate the retrieval of images that are both accurate and aesthetically pleasing from the system.” The meta prompt can also include instructions for formatting the query in a manner that is capable of being understood by the visual content search system. For example, a meta prompt can include the following language for causing the model to generate the query in a desired format: “The description should be constructed using the method outlined below: Generate a comma-separated list of succinct object descriptions, visual details, or stylistic elements, ordered from the most to the least significant.”

The meta prompt generating component may include a meta prompt generating model 226 which is trained to generate the meta prompt for the system. As discussed below, reinforcement training may be used to retrain model 226 based on user preferences derived from usage data. For example, user preference data can include information which indicates the types of visual content and/or characteristics of visual content that users are more likely to prefer to be retrieved in response to a given query term or combination of terms. The model is trained and reinforced to generate a meta prompt conditioned on current user preference data. In various implementations, the meta prompt generating model 226 comprises a generative language model, such as an LLM.

The refined query generating model 224 is trained to generate a refined visual content search query conditioned on the initial query and the meta prompt. As an example, an initial visual content query may request an image of a sofa with one or more descriptors, e.g., “a picture of a tan sofa.” An example of a refined query which may be generated based on such an initial query and a meta prompt according to this disclosure can read, for example, “Sleek modern sofa with clean lines, minimalist design, and neutral color palette, . . . ” The refined query generated by the model 224 can enhance the aesthetic quality of retrieved visual content, particularly in expressing abstract notions and stylistic elements.

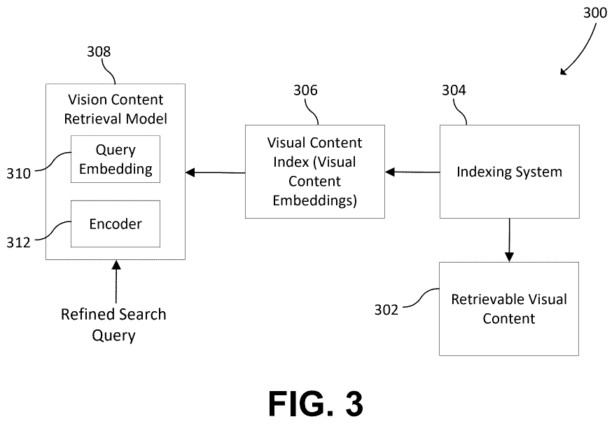

The refined search query is then provided to the visual content retrieval component 220. The visual content retrieval component 220 includes a vision language model 228 which is trained to retrieve the top k visual content that satisfies the refined search query with reference to a visual content index 230. An example implementation of a visual content retrieval component 300 is shown in FIG. 3. The visual content retrieval component 300 includes retrievable visual content 302, a visual content indexing system 304, a visual content index 306, and a visual content retrieval model 308. The retrievable visual content 302 includes images, videos, graphics, etc. from one or more sources which may be retrieved in response to a visual content search query. The indexing system 304 has access to the one or more sources of visual content and is configured to process the visual content offline to generate the visual content index 306 which in turn can be used by the content retrieval model 308 to identify the top k visual content to retrieve in response to a given query.

The indexing system 304 can use any suitable method or technique to generate the visual content index. In various implementations, the indexing system 304 is configured to utilize an Approximate k-Nearest Neighbor (ANN) indexing method/algorithm to generate an ANN index for the visual content. To generate the ANN index, the visual content is first mapped to an embedding space using an encoder, such as a transformer-based encoder, or other suitable machine learning (ML) or artificial intelligence (AI) model/algorithm. The embeddings are generated in a manner that enables the similarities between visual content features to be represented by the distances between embeddings. The visual content embeddings are stored in a data structure, such as a vector database.

The visual content retrieval model 308 comprises a vision language model (i.e., a text-to-visual content model) trained to process the refined query to generate a query feature vector, or query embedding 310, which can then be compared to the visual content index to retrieve the top k visual content. To this end, the visual content retrieval model 308 includes an encoder 312, such as a CLIP encoder, trained to map the text of the refined search query to the same embedding space to which the visual content is mapped. The visual content retrieval model 308 then utilizes an ANN algorithm to process the query embedding with regard to the visual content embeddings in the ANN index to retrieve the top k results. An ANN index enables fast and efficient searching by reducing the number of candidates that are searched for a given query. The goal of ANN searching is to find visual content embeddings (i.e., nearest neighbors) that approximate the query embedding without necessarily finding the exact nearest neighbor. For example, to enable fast searching of the ANN index, the embedding space may be divided into a plurality of zones. During a search, the index is scanned and zones that are unlikely to have the nearest neighbors are omitted from the search, and locations with a higher possibility of having nearest neighbors are selected for searching. Using an ANN search/index is faster, but less accurate than brute force methods because, in essence, the index is a lossy representation of the data. Examples of ANN searching/indexing techniques which may be utilized to retrieve top k visual content include hashing-based, tree-based, quantization-based, and graph-based.

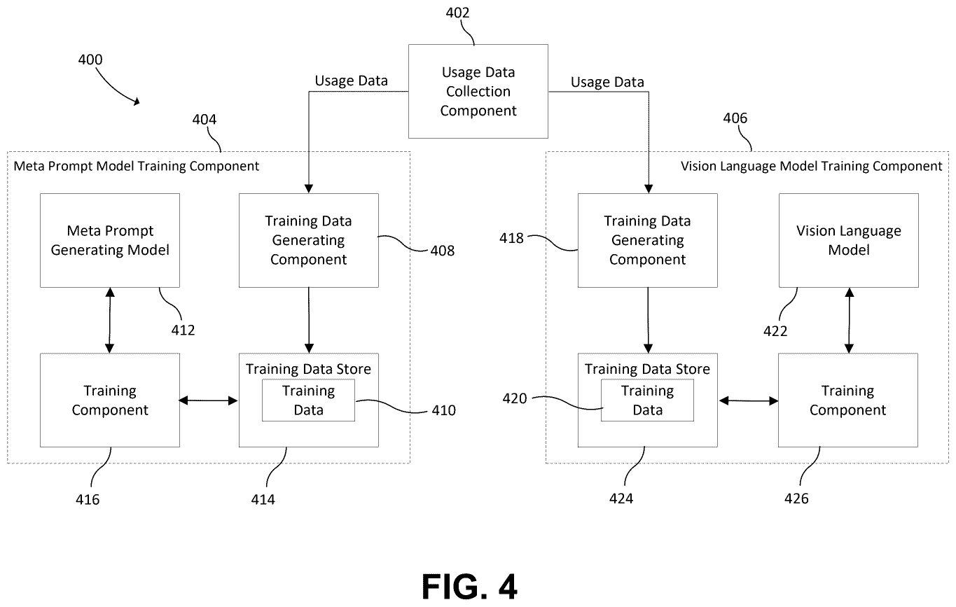

Returning to FIG. 2, the reinforcement training system 222 is configured to provide user preference-based reinforcement training for the meta prompt generating model and the vision language model. To this end, the visual content retrieval system 200 is configured to collect usage data 232 pertaining to usage of the system 200 by users over time. The usage data can be used to derive personal preference and feedback information which in turn can be used for reinforcement training of the refined query generating model 224 and the vision language model 228. An example implementation of a reinforcement training system 400 is shown in FIG. 4. The reinforcement training system 400 includes a usage data collection component 402, a meta prompt model training component 404, and a vision language model training component 406. The usage data collection component 402 collects usage data pertaining to the use of the visual content retrieval system over time. The usage data includes user interaction data, user preference data, user feedback data, and the like which can be used to derive user preferences as to preferred characteristics and types of visual content to retrieve based on query terminology as well as user satisfaction with the system performance.

The data collection component 402 can collect usage data in any suitable manner. In various implementations, the data collection component 402 is programmed to interact with the software applications via Application Programming Interfaces (APIs) of the applications to define the functions, commands, variables, and the like for causing the applications to generate and send relevant user information. The data collection component 402 may also include an API which defines the functions, commands, variables, and the like for designating parameters for data collection, such as applications and/or locations from which to collect information, types of information to collect, and the like. In various implementations, the data collection component comprises an enterprise data collection service which is utilized to collect user information across an enterprise or organization.

The meta prompt model training component 404 and the vision language model training component 406 each receive the collected usage data and are designed to generate training data for performing reinforcement training of the meta prompt model and the vision language model, respectively, based on the usage data. As shown in FIG. 4, the meta prompt model training component includes a training data generating component 408 which is configured to generate training data 410 for a meta prompt generating model 412 based on the training data and/or user preference information derived from the usage data. The training data can be used to reinforce rules which have been learned by the model to generate the meta prompt based on user preference data, to cause the model to learn new rules for generating the meta prompt based on user preference data, and/or to adapt the model to changes in user preferences derived from the usage data. The training data is stored in training data store. The training data 410 may be stored in a training data store 414 which is accessible to a model training component 416. The training component is configured to perform ongoing reinforcement training of the meta prompt generating model. In some cases, the training component 416 is also used to perform initial training of the model 412 as well. Reinforcement training can be performed on a periodic or as needed basis. For example, the training component 416 may be configured to perform reinforcement training once a month, when usage data indicates low user satisfaction with system performance, and/or when usage data indicates a change in user preferences.

The vision language model training component 406 includes a training data generating component 418 which is configured to generate training data 420 for a vision language model 422 based on the training data and/or user preference information derived from the usage data. The training data can be used to reinforce rules which have been learned by the model to identify the top-k visual content to retrieve for a given query. For example, the training data can be used to adjust the weights used in ranking/scoring visual content depending on query language, to cause the model to learn new rules for ranking/scoring visual content based on query language, and/or to adapt the model to changes in user preferences derived from the usage data. The training data 420 is stored in a training data store 424 which is accessible to a model training component 426. The training component 426 is configured to perform ongoing reinforcement training of the vision language model 422. The training component 426 may also be used to perform initial training of the model 422. Similar to meta prompt model training, reinforcement training of the vision language model 422 can be performed on a periodic or as needed basis.

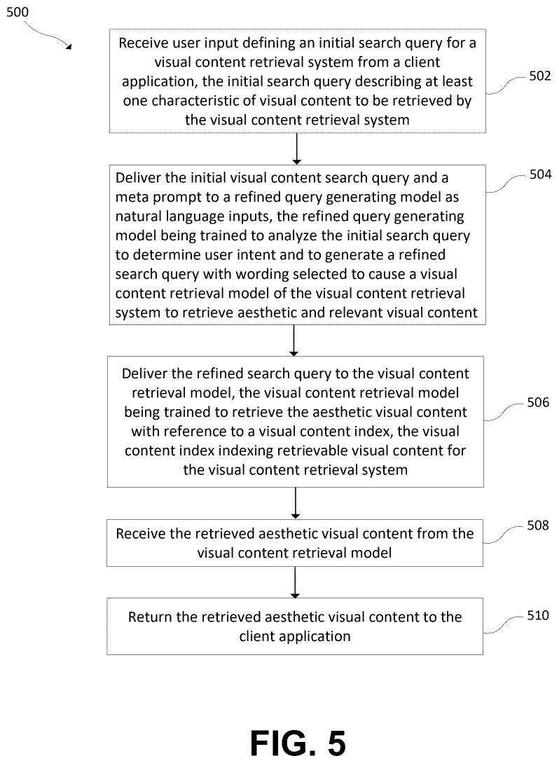

FIG. 5 shows a flowchart of an example method 500 of retrieving visual content using a visual content retrieval system, such as the system 200 of FIG. 2. The method 500 begins with receiving user input defining an initial search query for a visual content retrieval system from a client application (block 502). The initial search query describes at least one characteristic of visual content to be retrieved by the visual content retrieval system. The initial search query and a meta prompt is then delivered to a refined query generating model (block 504). The meta prompt includes instructions for causing the refined query generating model to generate the refined search query in a manner that aligns with user intent and that facilitates retrieval of visual content that is accurate and aesthetically pleasing. The refined query generating model is trained to analyze the initial search query to determine user intent and to generate the refined search query with wording selected to cause a visual content retrieval model of the visual content retrieval system to retrieve aesthetic visual content that satisfies the initial search query and that aligns with the determined user intent.

The refined search query is then delivered to a visual content retrieval model (block 506). The visual content retrieval model is trained to retrieve the aesthetic visual content with reference to a visual content index. The visual content index stores and organizes information about the retrievable visual content for the visual content retrieval system. The retrieved aesthetic visual content is then received from the visual content retrieval model (block 508). The retrieved aesthetic visual content is then returned to the client application (block 510).

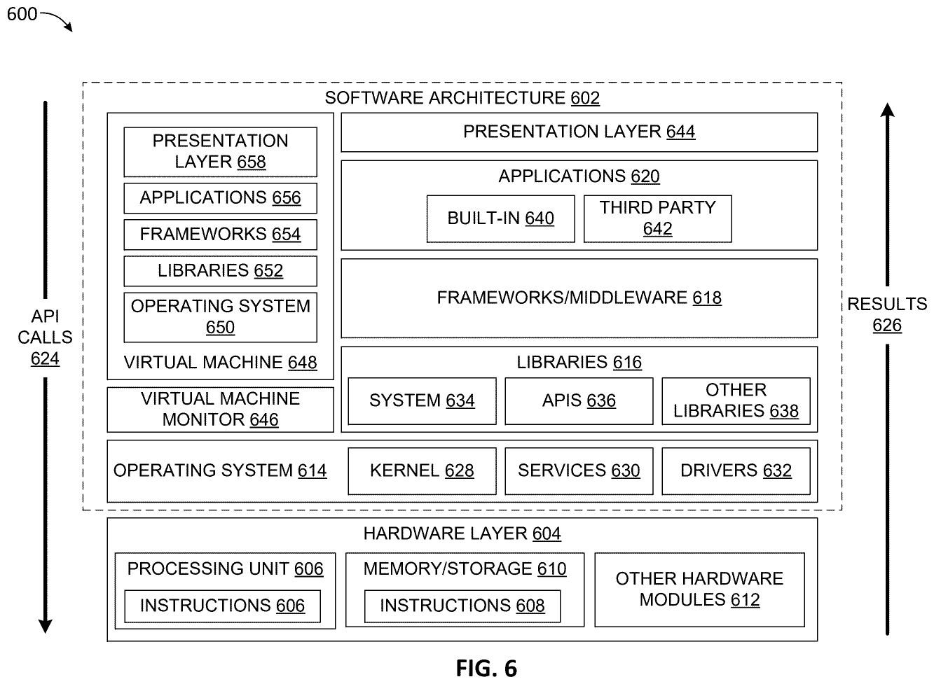

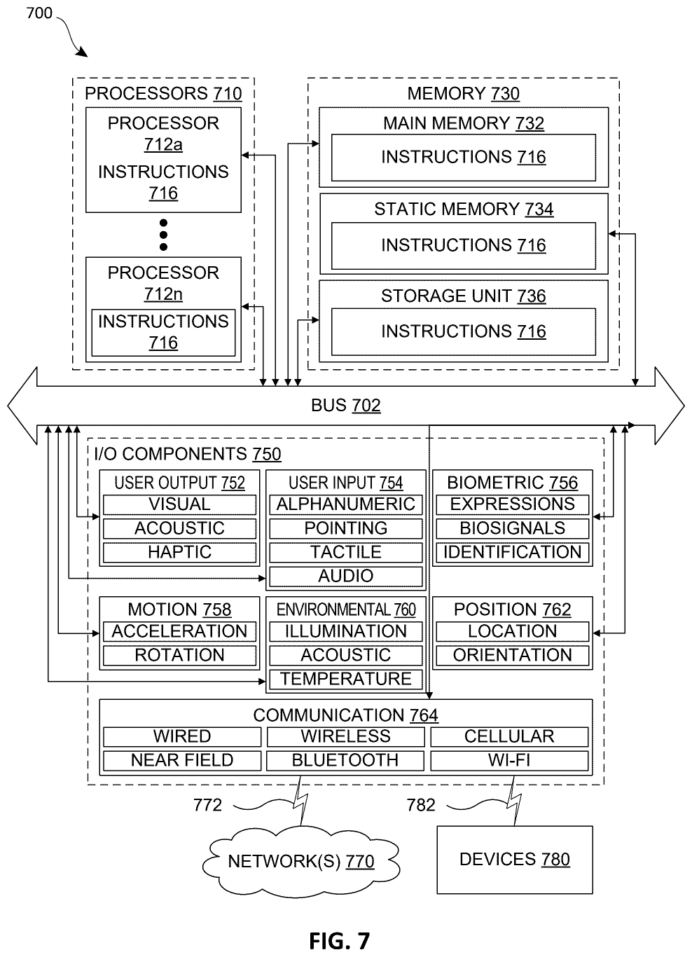

FIG. 6 is a block diagram 600 illustrating an example software architecture 602, various portions of which may be used in conjunction with various hardware architectures herein described, which may implement any of the above-described features. FIG. 6 is a non-limiting example of a software architecture, and it will be appreciated that many other architectures may be implemented to facilitate the functionality described herein. The software architecture 602 may execute on hardware such as a machine 700 of FIG. 7 that includes, among other things, processors 710, memory 730, and input/output (I/O) components 750. A representative hardware layer 604 is illustrated and can represent, for example, the machine 700 of FIG. 7. The representative hardware layer 604 includes a processing unit 606 and associated executable instructions 608. The executable instructions 608 represent executable instructions of the software architecture 602, including implementation of the methods, modules and so forth described herein. The hardware layer 604 also includes a memory/storage 610, which also includes the executable instructions 608 and accompanying data. The hardware layer 604 may also include other hardware modules 612. Instructions 608 held by processing unit 606 may be portions of instructions 608 held by the memory/storage 610.

The example software architecture 602 may be conceptualized as layers, each providing various functionality. For example, the software architecture 602 may include layers and components such as an operating system (OS) 614, libraries 616, frameworks/middleware 618, applications 620, and a presentation layer 644. Operationally, the applications 620 and/or other components within the layers may invoke API calls 624 to other layers and receive corresponding results 626. The layers illustrated are representative in nature and other software architectures may include additional or different layers. For example, some mobile or special purpose operating systems may not provide the frameworks/middleware 618.

The OS 614 may manage hardware resources and provide common services. The OS 614 may include, for example, a kernel 628, services 630, and drivers 632. The kernel 628 may act as an abstraction layer between the hardware layer 604 and other software layers. For example, the kernel 628 may be responsible for memory management, processor management (for example, scheduling), component management, networking, security settings, and so on. The services 630 may provide other common services for the other software layers. The drivers 632 may be responsible for controlling or interfacing with the underlying hardware layer 604. For instance, the drivers 632 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 616 may provide a common infrastructure that may be used by the applications 620 and/or other components and/or layers. The libraries 616 typically provide functionality for use by other software modules to perform tasks, rather than interacting directly with the OS 614. The libraries 616 may include system libraries 634 (for example, C standard library) that may provide functions such as memory allocation, string manipulation, file operations. In addition, the libraries 616 may include API libraries 636 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 616 may also include a wide variety of other libraries 638 to provide many functions for applications 620 and other software modules.

The frameworks 618 (also sometimes referred to as middleware) provide a higher-level common infrastructure that may be used by the applications 620 and/or other software modules. For example, the frameworks/middleware 618 may provide various graphic user interface (GUI) functions, high-level resource management, or high-level location services. The frameworks/middleware 618 may provide a broad spectrum of other APIs for applications 620 and/or other software modules.

The applications 620 include built-in applications 640 and/or third-party applications 642. Examples of built-in applications 640 may include, but are not limited to, a contacts application, a browser application, a location application, a media application, a messaging application, and/or a game application. Third-party applications 642 may include any applications developed by an entity other than the vendor of the particular platform. The applications 620 may use functions available via OS 614, libraries 616, frameworks/middleware 618, and presentation layer 644 to create user interfaces to interact with users.

Some software architectures use virtual machines, as illustrated by a virtual machine 648. The virtual machine 648 provides an execution environment where applications/modules can execute as if they were executing on a hardware machine (such as the machine 700 of FIG. 7, for example). The virtual machine 648 may be hosted by a host OS (for example, OS 614) or hypervisor, and may have a virtual machine monitor 646 which manages operation of the virtual machine 648 and interoperation with the host operating system. A software architecture, which may be different from software architecture 602 outside of the virtual machine, executes within the virtual machine 648 such as an OS 650, libraries 652, frameworks 654, applications 656, and/or a presentation layer 658.

FIG. 7 is a block diagram illustrating components of an example machine 700 configured to read instructions from a machine-readable medium (for example, a machine-readable storage medium) and perform any of the features described herein. The example machine 700 is in a form of a computer system, within which instructions 716 (for example, in the form of software components) for causing the machine 700 to perform any of the features described herein may be executed. As such, the instructions 716 may be used to implement modules or components described herein. The instructions 716 cause unprogrammed and/or unconfigured machine 700 to operate as a particular machine configured to carry out the described features. The machine 700 may be configured to operate as a standalone device or may be coupled (for example, networked) to other machines. In a networked deployment, the machine 700 may operate in the capacity of a server machine or a client machine in a server-client network environment, or as a node in a peer-to-peer or distributed network environment. Machine 700 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 700 is illustrated, the term “machine” includes a collection of machines that individually or jointly execute the instructions 716.

The machine 700 may include processors 710, memory 730, and I/O components 750, which may be communicatively coupled via, for example, a bus 702. The bus 702 may include multiple buses coupling various elements of machine 700 via various bus technologies and protocols. In an example, the processors 710 (including, for example, a central processing unit (CPU), a graphics processing unit (GPU), a digital signal processor (DSP), an ASIC, or a suitable combination thereof) may include one or more processors 712a to 712n that may execute the instructions 716 and process data. In some examples, one or more processors 710 may execute instructions provided or identified by one or more other processors 710. The term “processor” includes a multicore processor including cores that may execute instructions contemporaneously. Although FIG. 7 shows multiple processors, the machine 700 may include a single processor with a single core, a single processor with multiple cores (for example, a multicore processor), multiple processors each with a single core, multiple processors each with multiple cores, or any combination thereof. In some examples, the machine 700 may include multiple processors distributed among multiple machines.

The memory/storage 730 may include a main memory 732, a static memory 734, or other memory, and a storage unit 736, both accessible to the processors 710 such as via the bus 702. The storage unit 736 and memory 732, 734 store instructions 716 embodying any one or more of the functions described herein. The memory/storage 730 may also store temporary, intermediate, and/or long-term data for processors 710. The instructions 716 may also reside, completely or partially, within the memory 732, 734, within the storage unit 736, within at least one of the processors 710 (for example, within a command buffer or cache memory), within memory at least one of I/O components 750, or any suitable combination thereof, during execution thereof. Accordingly, the memory 732, 734, the storage unit 736, memory in processors 710, and memory in I/O components 750 are examples of machine-readable media.

As used herein, “machine-readable medium” refers to a device able to temporarily or permanently store instructions and data that cause machine 700 to operate in a specific fashion, and may include, but is not limited to, random-access memory (RAM), read-only memory (ROM), buffer memory, flash memory, optical storage media, magnetic storage media and devices, cache memory, network-accessible or cloud storage, other types of storage and/or any suitable combination thereof. The term “machine-readable medium” applies to a single medium, or combination of multiple media, used to store instructions (for example, instructions 716) for execution by a machine 700 such that the instructions, when executed by one or more processors 710 of the machine 700, cause the machine 700 to perform and one or more of the features described herein. Accordingly, a “machine-readable medium” may refer to a single storage device, as well as “cloud-based” storage systems or storage networks that include multiple storage apparatus or devices. The term “machine-readable medium” excludes signals per se.

The I/O components 750 may include a wide variety of hardware components adapted to receive input, provide output, produce output, transmit information, exchange information, capture measurements, and so on. The specific I/O components 750 included in a particular machine will depend on the type and/or function of the machine. For example, mobile devices such as mobile phones may include a touch input device, whereas a headless server or IoT device may not include such a touch input device. The particular examples of I/O components illustrated in FIG. 7 are in no way limiting, and other types of components may be included in machine 700. The grouping of I/O components 750 are merely for simplifying this discussion, and the grouping is in no way limiting. In various examples, the I/O components 750 may include user output components 752 and user input components 754. User output components 752 may include, for example, display components for displaying information (for example, a liquid crystal display (LCD) or a projector), acoustic components (for example, speakers), haptic components (for example, a vibratory motor or force-feedback device), and/or other signal generators. User input components 754 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 750 may include biometric components 756, motion components 758, environmental components 760, and/or position components 762, among a wide array of other physical sensor components. The biometric components 756 may include, for example, components to detect body expressions (for example, facial expressions, vocal expressions, hand or body gestures, or eye tracking), measure biosignals (for example, heart rate or brain waves), and identify a person (for example, via voice-, retina-, fingerprint-, and/or facial-based identification). The motion components 758 may include, for example, acceleration sensors (for example, an accelerometer) and rotation sensors (for example, a gyroscope). The environmental components 760 may include, for example, illumination sensors, temperature sensors, humidity sensors, pressure sensors (for example, a barometer), acoustic sensors (for example, a microphone used to detect ambient noise), proximity sensors (for example, infrared sensing of nearby objects), and/or other components that may provide indications, measurements, or signals corresponding to a surrounding physical environment. The position components 762 may include, for example, location sensors (for example, a Global Position System (GPS) receiver), altitude sensors (for example, an air pressure sensor from which altitude may be derived), and/or orientation sensors (for example, magnetometers).

The I/O components 750 may include communication components 764, implementing a wide variety of technologies operable to couple the machine 700 to network(s) 770 and/or device(s) 780 via respective communicative couplings 772 and 782. The communication components 764 may include one or more network interface components or other suitable devices to interface with the network(s) 770. The communication components 764 may include, for example, components adapted to provide wired communication, wireless communication, cellular communication, Near Field Communication (NFC), Bluetooth communication, Wi-Fi, and/or communication via other modalities. The device(s) 780 may include other machines or various peripheral devices (for example, coupled via USB).

In some examples, the communication components 764 may detect identifiers or include components adapted to detect identifiers. For example, the communication components 764 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 764, such as, but not limited to, geo-location via Internet Protocol (IP) address, location via Wi-Fi, cellular, NFC, Bluetooth, or other wireless station identification and/or signal triangulation.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element. Furthermore, subsequent limitations referring back to “said element” or “the element” performing certain functions signifies that “said element” or “the element” alone or in combination with additional identical elements in the process, method, article or apparatus are capable of performing all of the recited functions.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A data processing system comprising:
a processor; and
a memory in communication with the processor, the memory comprising executable instructions that, when executed by the processor alone or in combination with other processors, cause the data processing system to perform functions of:
receiving user input defining an initial search query for a visual content retrieval system from a client application, the initial search query describing at least one characteristic of visual content to be retrieved by the visual content retrieval system;
delivering the initial visual content search query and a meta prompt to a refined query generating model as natural language inputs, the refined query generating model being trained to analyze the initial search query to determine user intent and to generate a refined search query with wording selected to cause a visual content retrieval model of the visual content retrieval system to retrieve aesthetic visual content based on the initial search query and the meta prompt;
delivering the refined search query to the visual content retrieval model, the visual content retrieval model being trained to retrieve the aesthetic visual content with reference to a visual content index, the visual content index indexing retrievable visual content for the visual content retrieval system;
receiving the retrieved aesthetic visual content from the visual content retrieval model; and
returning the retrieved aesthetic visual content to the client application.

2. The data processing system of claim 1, wherein the meta prompt includes instructions for causing the refined query generating model to generate the refined search query in a manner that aligns with the user intent and that facilitates retrieval of visual content that is accurate and aesthetically pleasing.

3. The data processing system of claim 2, wherein the meta prompt also includes instructions for how to format the refined search query.

4. The data processing system of claim 3, wherein the refined query generating model comprises a Large Language Model (LLM).

5. The data processing system of claim 1, wherein:
the visual content index is created by generating visual content embeddings for the retrievable visual content that maps the retrievable visual content to an embedding space,
the visual content retrieval model includes an encoder for generating a query embedding that maps the refined search query to the embedding space, and
the visual content retrieval model is trained to compare the query embedding to the visual content embeddings in the visual content index to identify a predetermined number of top visual content to retrieve in response to the refined search query.

6. The data processing system of claim 1, wherein:
the visual content index is an Approximate k-Nearest Neighbors (ANN) index.

7. The data processing system of claim 1, wherein the visual content retrieval model comprises a vision language model.

8. The data processing system of claim 1, wherein the meta prompt is generated using a meta prompt generating model.

9. The data processing system of claim 8, wherein the functions further comprise:
collecting usage data pertaining to usage of the visual content retrieval system;
performing reinforcement training of at least one of the meta prompt generating model and the visual content retrieval model using training data derived from the usage data.

10. A method of retrieving visual content using a visual content retrieval system, the method comprising:
receiving user input defining an initial search query for a visual content retrieval system from a client application, the initial search query describing at least one characteristic of visual content to be retrieved by the visual content retrieval system;
delivering the initial visual content search query and a meta prompt to a refined query generating model as natural language inputs, the refined query generating model being trained to analyze the initial search query to determine user intent and to generate a refined search query with wording selected to cause a visual content retrieval model of the visual content retrieval system to retrieve aesthetic visual content based on the initial search query and the meta prompt;
delivering the refined search query to the visual content retrieval model, the visual content retrieval model being trained to retrieve the aesthetic visual content with reference to a visual content index, the visual content index indexing retrievable visual content for the visual content retrieval system;
receiving the retrieved aesthetic visual content from the visual content retrieval model; and
returning the retrieved aesthetic visual content to the client application.

11. The method of claim 10, wherein the meta prompt includes instructions for causing the refined query generating model to generate the refined search query in a manner that aligns with user intent and that facilitates retrieval of visual content that is accurate and aesthetically pleasing.

12. The method of claim 11, wherein the meta prompt also includes instructions for how to format the refined search query.

13. The method of claim 12, wherein the refined query generating model comprises a Large Language Model (LLM).

14. The method of claim 10, wherein:
the visual content index is created by generating visual content embeddings for the retrievable visual content that maps the retrievable visual content to an embedding space,
the visual content retrieval model includes an encoder for generating a query embedding that maps the refined search query to the embedding space, and
the visual content retrieval model is trained to compare the query embedding to the visual content embeddings in the visual content index to identify a predetermined number of top visual content to retrieve in response to the refined search query.

15. The method of claim 10, wherein:
the visual content index is an Approximate k-Nearest Neighbors (ANN) index.

16. The method of claim 10, wherein the visual content retrieval model comprises a vision language model.

17. The method of claim 10, wherein the meta prompt is generated using a meta prompt generating model.

18. The method of claim 17, further comprising:
collecting usage data pertaining to usage of the visual content retrieval system;
performing reinforcement training of at least one of the meta prompt generating model and the visual content retrieval model using training data derived from the usage data.

19. A non-transitory computer readable medium on which are stored instructions that, when executed, cause a programmable device to perform functions of:
receiving user input defining an initial search query for a visual content retrieval system from a client application, the initial search query describing at least one characteristic of visual content to be retrieved by the visual content retrieval system;
delivering the initial visual content search query and a meta prompt to a refined query generating model as natural language inputs, the refined query generating model being trained to analyze the initial search query to determine user intent and to generate a refined search query with wording selected to cause a visual content retrieval model of the visual content retrieval system to retrieve aesthetic visual content based on the initial search query and the meta prompt;
delivering the refined search query to the visual content retrieval model, the visual content retrieval model being trained to retrieve the aesthetic visual content with reference to a visual content index, the visual content index indexing retrievable visual content for the visual content retrieval system;
receiving the retrieved aesthetic visual content from the visual content retrieval model; and
returning the retrieved aesthetic visual content to the client application.

20. The non-transitory computer readable medium of claim 19, wherein the functions further comprise:
collecting usage data pertaining to usage of the visual content retrieval system; and
performing reinforcement training of at least one of the meta prompt generating model and the visual content retrieval model using training data derived from the usage data.
